(19) United States
(12) Patent Application Publication
(10) Pub. No.: US 2007/0154811 A1
(43) Pub. Date: Jul. 5, 2007

(54) Carbonaceous electrode material for secondary battery, process for producing the same, and secondary batteries using the same

(76) Inventors: Jeong-Hun Oh, Gyeonggi-do (KR); Jong-Sung Kim, Gyeonggi-do (KR); Ho-Gun Kim, Seoul (KR); Dong-Hun Shin, Gyeonggi-do (KR); Chul Youm, Gyeonggi-do (KR)

Correspondence Address: JONES DAY, 222 EAST 41ST ST, NEW YORK, NY, 10017, US

(21) Appl. No.: 11/649,669

(22) Filed: Jan. 3, 2007

(30) Foreign Application Priority Data
Jan. 4, 2006 (KR) 10-2006-0000956

(51) Int. Cl. H01M 4/58; H01M 4/62; C01D 3/00

(52) U.S. Cl. 429/231.8; 429/232; 423/449.1

(57) ABSTRACT

The carbonaceous electrode material for a secondary battery includes a core carbonaceous material composed of high-crystallinity graphite, and a surface covering, layer coated to surround the core carbonaceous material. The surface covering layer is formed of a mixture of a shape-controlled metallic material and a pitch which is an amorphous carbonaceous material. A surface of the core carbonaceous material has a low-crystallinity structure. The carbonaceous electrode material for a secondary battery is useful to produce a secondary battery having excellent cycle characteristics and charging/discharging efficiency by minimizing a volume change of the secondary battery upon charging/discharging of the battery thereby to prevent a bond between the core carbonaceous material and the covering layer from being ruptured or isolated.

### BACKGROUND OF THE INVENTION

1. Field of the invention

The present invention relates to a carbonaceous electrode material for a secondary battery, a process for producing the same and a secondary battery using the same, more particularly to a carbonaceous electrode material for a secondary battery capable of minimizing expansion of an electrode upon battery charging and also improving a cycle characteristic and a charging/discharging efficiency by coating the core carbonaceous material with a low-crystallinity carbonaceous material and a shape-controlled metallic material, a process for producing the same, and a secondary battery using the same.

2. Description of the Related Art

Recently, there have been increasing demands for a small-sized and lightweight secondary battery having a relatively high capacity, and this trend has been accelerated as electronic apparatuses using a battery, for example mobile phones, portable notebook computers, electric vehicles, etc., come into wide use.

Natural graphite, used as an anode active material of the secondary battery, has an excellent initial discharging capacity, but has a problem that a charging/discharging efficiency and a charging/discharging capacity are rapidly deteriorated as charge/discharge cycles of the secondary battery are repeated. Meanwhile it has been known that graphite used as an anode active material for a lithium secondary battery known up to date has a discharging capacity of 372 mAh/g, which is a theoretical threshold. There have been some of ardent attempts to develop an anode active material having a higher discharging capacity than the conventional graphite.

Silver (Ag), silicon (Si), tin (Sn), etc. have been investigated as materials which may be used instead of the graphite, and it was revealed that these materials or compounds have a higher discharging capacity than that of the graphite by forming an alloy with lithium. However, the discharging capacity is not the only factor to be considered so as to apply the materials to a battery, and there are other problems to be solved, such as expansion of a battery by a volume change of an active material upon charging/discharging of the battery, and improvement of a charging/discharging efficiency. Accordingly, there have been recently attempts to develop a method in which metallic materials such as silver (Ag), silicon (Si), tin (Sn), and compounds thereof are used in combination with graphite used in the prior art, instead of using the metallic materials and their compounds alone as the active material.

However, in spite of these new attempts, the expansion of the metallic materials ruptures their bonds to the amorphous carbonaceous material, or the metallic materials are isolated from graphite-based carbonaceous materials as charge/discharge cycles of the secondary battery are repeated, and therefore a cycle characteristic was aggravated since the metallic materials may not be suitably used as the anode active material. As a specific example, Korean Patent Laid-open Publication No. 10-2002-70764 discloses a carbonaceous material for a lithium secondary battery manufactured by dispersing composite particles on a surface of graphite particle, the composite particle being coated with a hardened carbon film including silicon and carbon, and coating the surface of graphite particle with an amorphous carbon film, so as to solve the problem on the volume change upon charging and discharging caused when silicon is used as the anode material. But, the above-mentioned method has problems that its processes are too complicated and a charging/discharging efficiency of a battery is lowered by a double-coated amorphous carbon film, and therefore there has been a demand for essential technical improvements.

In order to solve the conventional problems caused when a predetermined metallic material is used as an electrode material, there have been ardent attempts to develop a carbonaceous electrode material for a secondary battery, and therefore the present invention was designed, based on above-mentioned facts.

### SUMMARY OF THE INVENTION

The present invention is designed to solve the problems of the prior art, and therefore it is an object of the present invention to provide a carbonaceous electrode material for a secondary battery having a higher discharging capacity than a conventional graphite used in the art, the carbonaceous electrode material capable of improving a cycle characteristic and a charging/discharging efficiency and also simplifying a complicated production process of the carbonaceous electrode material, by minimizing a volume change upon charging/discharging of the battery and preventing a bond between a core carbonaceous material and a covering layer of the battery from being destroyed or isolated, a process for producing the same, and a secondary battery using the same.

In order to accomplish the above object, the present invention provides a carbonaceous electrode material for a secondary battery including a core carbonaceous material composed of high-crystallinity graphite; and a surface covering layer coated to surround the core carbonaceous material, wherein the surface covering layer is formed of a mixture of a shape-controlled metallic material and an amorphous carbonaceous material which is a pitch, and a surface of the core carbonaceous material has a low-crystallinity structure.

In order to accomplish the above object, the present invention provides a process for producing a carbonaceous electrode material for a secondary battery, including: (S1) weighing a core carbonaceous material composed of high-crystallinity graphite, a pitch which is an amorphous carbonaceous material, and a shape-controlled metallic material powder; (S2) dissolving the amorphous carbonaceous material in tetrahydrofuran (THF) and adding the shape-controlled metallic material powder thereto, followed by mixing the amorphous carbonaceous material and the shape-controlled metallic material powder while stirring; (S3) adding the core carbonaceous material composed of the high-crystallinity graphite to the mixture of the step (S2) and mixing the resultant mixture by means of wet stirring, followed by drying the mixture; and (S4) calcining the mixture of the step (S3). The production process according to the present invention preferably further includes a step of distributing the calcined material to remove a fine powder after the calcination step (S4).

In the carbonaceous electrode material for a secondary battery or the production process of the carbonaceous electrode material for a secondary battery as described above, the metallic material is preferably a material shape-controlled to have at least one shape selected from the group Consisting of a hollow spherical shape, a spherical shape and a rod shape, and also is preferably at least one material selected from the group consisting of silver (Ag), silicon (Si) and tin (Sn), the high-crystallinity graphite constituting the core carbonaceous material is preferably at least one material selected from the group consisting of natural graphite and synthetic graphite, and the pitch which is an amorphous carbonaceous material is preferably at least one material selected from the group consisting of petroleum pitch and coal pitch.

In connection with the shapes of the metallic material, the hollow spherical shape is referred to as a shape in which a particle having an aspect ratio of 0.5 or more accounts for at least 90% of the total particle and which has a hollow space inside the particle, the spherical shape is referred to as a shape in which a particle having an aspect ratio of 0.5 or more accounts for at least 90% of the total particle, the rod shape is referred to as a shape in which a particle having a length a 2 to 5 μm and a diameter of 0.1 to 1 μm accounts for at least 80% of the total particle, and the amorphous shape is referred to as a shape in which a particle has an aspect ratio of 0.5 or less and does not have a constant shape. Meanwhile, the metallic material, selected from the group consisting of silver (Ag), silicon (Si) and tin (Sn), preferably has a mean particle diameter of 0.5 to 1.0 μm.

In order to accomplish the above object, the present invention provides a secondary battery produced using, as a battery anode, the carbonaceous electrode material for a secondary battery or the anode material for a secondary battery produced according to the process for producing the carbonaceous electrode material for a secondary battery as described above. At this time, the secondary battery preferably has a discharging capacity of 400 mAh/g or more, a charging/discharging efficiency of 88% or more and an electrode expansion ratio of 150% or less.

In the production process of a carbonaceous electrode material for a secondary battery as described above, 70 to 95% by weight of the core carbonaceous material; 5 to 30% by weight of the amorphous carbonaceous material; and 1 to 5% by weight of the metallic material are preferably prepared as a material powder, respectively. If the content of the core carbonaceous material is less than the lower numerical limit, an efficiency of the secondary battery is lowered due to an increased amount of the amorphous carbon, while it is difficult to coat the core carbonaceous material with the amorphous carbon and the metallic material if the content exceeds the upper numerical limit. It is difficult to coat the core carbonaceous material with the metallic material if the content of the amorphous carbonaceous material is less than the lower numerical limit, while battery characteristics are deteriorated if the content exceeds the upper numerical limit. It is difficult to enhance a capacity of the secondary battery if the content of the metallic material is less than the lower numerical limit, while it is difficult to control the electrode expansion upon charging/discharging of the battery if the content exceeds the upper numerical limit.

The amorphous carbonaceous material prepared as described above is dissolved in an organic solvent, for example tetrahydrofuran (THF), and then the shape-controlled metallic material powder was added and mixed while stirring.

Preferably, the core carbonaceous material composed of the high-crystallinity graphite is added to the resultant mixture, wet-stirred at a room temperature for 2 hours, and then dried at 80 to 150° C. while stirring for 4 hours under a reduced pressure.

The dried mixture is preferably calcined at 800 to 1,000° C. for 1 to 24 hours. A carbonization degree of the amorphous carbonaceous material is insufficient if the calcination temperature is less than 800° C. while it is possible to change a shape of the metallic material if the calcination temperature exceeds 1000° C.

### BRIEF DESCRIPTION OF THE DRAWINGS

Other objects and aspects of the present invention will become apparent from the following description of embodiments with reference to the accompanying drawings. However, it should be understood that the description proposed herein is just a preferable example for the purpose of illustrations only, not intended to limit the scope of the invention. In the drawings:

FIG. 1 is a flowchart illustrating a process for producing an electrode using a carbonaceous electrode material for a secondary battery according to the present invention.

### DESCRIPTION OF THE PREFERRED EMBODIMENT

Hereinafter preferred embodiments of the present invention will be described in detail referring to the accompanying drawings. However, the description proposed herein is just a preferable example for the purpose of illustrations only, not intended to limit the scope of the invention, so it should be understood that other equivalents and modifications could be made thereto without departing from the spirit and scope of the invention. The preferred embodiments of the present invention will be described in detail for the purpose of better understandings, as apparent to those skilled in the art.

### Embodiments 1 to 3 and Comparative examples 1 and 2

87% by weight of spherical natural graphite as the core carbonaceous material, 10% by weight of a petroleum pitch as the amorphous carbonaceous material, and 3% by weight of a hollow spherical silver (Ag) powder as the metallic material were prepared in Embodiment 1 according to the present invention. The prepared petroleum pitch was dissolved in tetrahydrofuran (THF), and then the prepared hollow spherical silver (Ag) powder was added thereto and homogeneously mixed together while stirring. The prepared spherical natural graphite was added to the resultant mixture, mixed for at least 2 hours under an ambient pressure by means of wet stirring, and then dried under a reduced pressure. Subsequently, the dried mixture was calcined at 900° C. for 2 hours, and then distributed to remove a fine powder, thereby to produce a carbonaceous electrode material.

Carbonaceous electrode materials were produced in Embodiments 2 and 3 and Comparative example 2 in the same manner as described in the above-mentioned Embodiment 1, except that silver (Ag) powders having different shapes such as a spherical shape, a rod shape and an amorphous shape, as listed in the following Table 1, were used respectively as the metallic material instead of the hollow spherical silver (Ag) powder used as the metallic material in Embodiment 1.

Meanwhile, the metallic material was not used in Comparative example 1. That is to say, the spherical natural graphite and the petroleum pitch were prepared in Comparative example 1, and then 10% by weight of the petroleum pitch was dissolved in tetrahydrofuran (THF), 90% by weight of the spherical natural graphite was added thereto, mixed for at least 2 hours under an ambient pressure by means of wet stirring, and then dried under a reduced pressure to produce a mixture. The resultant mixture was calcined at 900° C. for 2 hours, and then distributed to remove a fine powder, thereby to produce a carbonaceous electrode material.

TABLE 1

| | | Core | Amorphous | Metallic |
|---|---|---|---|---|
| | | Carbonaceous | Carbonaceous | Material |
| | | Material | Material | (Ag powder) |
| Embodiments | 1 | Spherical Natural | Petroleum Pitch | Hollow |
| | | Graphite | | Spherical |
| | | | | Shape |
| | 2 | Spherical Natural | Petroleum Pitch | Spherical |
| | | Graphite | | Shape |
| | 3 | Spherical Natural | Petroleum Pitch | Rod Shape |
| | | Graphite | | |
| Comparative | 1 | Spherical Natural | Petroleum Pitch | — |
| examples | | Graphite | | |
| | 2 | Spherical Natural | Petroleum Pitch | Amorphous |
| | | Graphite | | Shape |

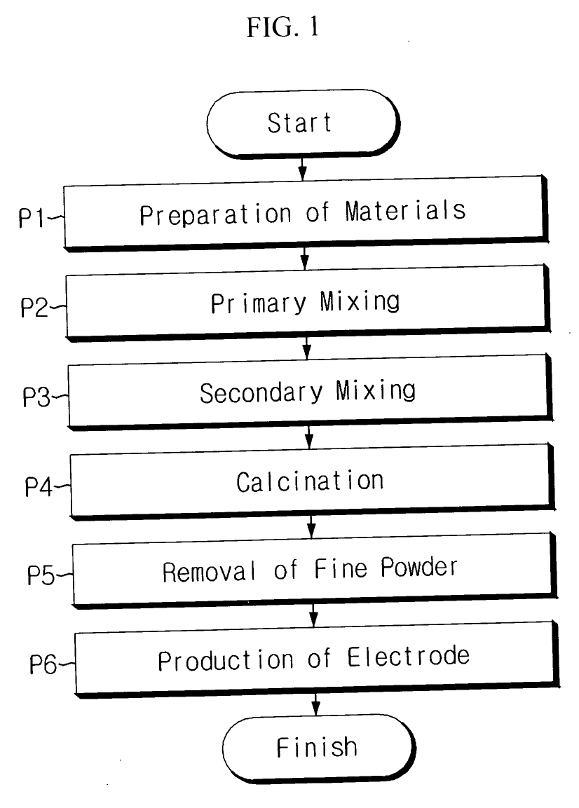

FIG. 1 is a flowchart illustrating a process for producing an electrode of coin cell using a carbonaceous electrode material for a secondary battery according to the present invention.

Preparation of Materials (P1)

Powders of a core carbonaceous material composed of high-crystallinity graphite, a pitch which is an amorphous carbonaceous material, and a shape-controlled metallic material are weighed, respectively. In particular, 70 to 95% by weight of the core carbonaceous material, 5 to 30% by weight of the amorphous carbonaceous material, 1 to 5% by weight of the metallic material are preferably prepared as the material powders.

Primary Mixing of Materials (P2)

The prepared amorphous carbonaceous materials are dissolved in an organic solvent tetrahydrofuran (THF), and the prepared shape-controlled metallic material powders is added thereto, and then mixed while stirring.

Secondary Mixing of Materials (P3)

The core carbonaceous material composed of the high-crystallinity graphite is added to the mixture obtained in the primary mixing of materials (P2), mixed by means of wet stirring, and then dried. Preferably, the core carbonaceous material composed of high-crystallinity graphite is added to the mixture, stirred at a room temperature for at least 2 hours, and then dried at 80 to 150° C. for 4 hours under a reduced pressure while stirring.

Calcination (P4)

The dried mixture is preferably calcined at 800 to 1,000° C. for 1 to 24 hours.

Removal of Fine Powder (P5)

The calcined material is distributed to remove a fine powder.

Production of Electrode (P6)

An anode of a battery is made using the obtained carbonaceous electrode material.

Production Example of Electrode

Electrode materials were made of the materials according to Embodiments 1 to 3 and Comparative examples 1 and 2, and then coin cells were produced according to the production process of the electrode as described above, and measured for a charging/discharging capacity and a cycle characteristic, respectively.

100 of the carbonaceous electrode materials, produced according to Embodiments 1 to 3 and Comparative examples 1 and 2 as described above, was added to a 500 ml mixer, respectively, and a small amount of N-methylpyrrolidone (NMP) and polyvinylidene fluoride (PVDF) as a binder were also added thereto, and then mixed using the mixer. Subsequently, copper foils were coated with the resultant mixture, and an electrode having (an electrode density of 1.5 g/cm³ and an electrode thickness of 70 μm was used as an anode of the coin cell. Subsequently, the coin cells were measured for a charging/discharging capacity and a cycle characteristic.

Measurement of Battery Properties (Discharging Capacity and Charging/Discharging Efficiency)

Charge/discharge tests on the coin cells were carried out, the coin cells being produced using, as an anode material, each of the carbonaceous electrode materials for a secondary battery which were respectively produced according to Embodiments 1 to 3 and Comparative examples 1 and 2, as follows. The results are listed in the following Table 2.

The charge/discharge tests were carried out by limiting an electric potential to a range of 0 to 1.5 V. That is, a secondary battery was charged with a charging current of 0.5 mA/cm² to a voltage of 0.01 V, and then also continuously charged to a charging current of 0.02 mA/cm² while maintaining the voltage of 0.01 V. And, the secondary battery was then discharged with a discharging current of 0.5 mA/cm² to a voltage of 1.5 V. The charging/discharging efficiency is represented by a ratio of a discharged electric capacity to a charged electric capacity, as listed in the following Table 2.

Evaluation of Cycle Characteristic

A cycle characteristic of the battery was evaluated by measuring, an electric capacity after 30 charge/discharge cycles.

Measurement of Electrode Expansion Ratio

Meanwhile, in order to determine an expansion ratio of the anode material upon charging/discharging of the secondary battery, the charged coin cells were disassembled and their electrode thickness was measured. The results are listed in the following Table 2.

Meanwhile, it may be assessed that the present invention sufficiently meets desired effects of the secondary battery if the secondary battery, produced according to the present invention, has a discharging capacity of 400 mAh/g or more, a charging/discharging efficiency of 88% or more and an electrode expansion ratio of 150% or less.

TABLE 2

| | | 1 Cycle | | | | |
|---|---|---|---|---|---|---|
| | | | Charging/ | Electrode | 30 Cycles | |
| | | Discharging | Discharging | Expansion | Discharging | Electrode |
| | | Capacity | Efficiency | Ratio | Capacity | Expansion |
| | | (mAh/g) | (%) | (%) | (mAh/g) | Ratio (%) |
| Embodiments | 1 | 421.3 | 91.5 | 129.8 | 323.5 | 141.5 |
| | 2 | 411.3 | 89.3 | 133.9 | 292.0 | 147.3 |
| | 3 | 408.2 | 88.7 | 133.5 | 293.9 | 146.2 |
| Comparative | 1 | 349.8 | 92.2 | 126.6 | 268.2 | 135.2 |
| examples | 2 | 396.4 | 86.1 | 136.7 | 288.3 | 150.4 |

As seen in the Table 2, it was revealed that all the secondary batteries have a discharging capacity greater than 400 mAh/g after one charge/discharge cycle and greater than 290 mAh/g after 30 charge/discharge cycles in the case of the Embodiments 1 to 3. On the while, it was revealed that the secondary batteries have a very low discharging capacity in the case of the Comparative examples 1 and 2. Meanwhile, it was revealed that there is no significant difference between the embodiments and the comparative examples in the charging/discharging efficiency and the electrode expansion ratio after the one cycle, but the electrode expansion ratios in the Embodiments 1 to 3 were all higher than the Comparative example 1 and lower than the Comparative example 2.

As described above, the best embodiments of the present invention are disclosed. Therefore, the specific terms are used in the specification and appended claims, but it should be understood that the description proposed herein is just a preferable example for the purpose of illustrations only, not intended to limit the scope of the invention.

### APPLICABILITY TO THE INDUSTRY

As described above, the carbonaceous electrode material for a secondary battery according to the present invention may be useful to produce a secondary battery having excellent cycle characteristics and charging/discharging efficiency by minimizing a volume change of the secondary battery upon charging/discharging of the battery due to use of the shape-controlled metallic material in the covering layer surrounding the core carbonaceous material, thereby to prevent a bond between the core carbonaceous material and the covering layer from being ruptured or isolated, wherein the carbonaceous electrode material is produced by coating a high-crystallinity core carbonaceous material with a low-crystallinity carbonaceous material including a shape-controlled metallic material, and then undergoing a predetermined calcination process.

What is claimed is:

1. A carbonaceous electrode material for a secondary battery, comprising:
a core carbonaceous material composed of high-crystallinity graphite; and
a surface covering layer coated to surround the core carbonaceous material,
wherein the surface covering layer is formed of a mixture of a shape-controlled metallic material and a pitch which is an amorphous carbonaceous material, and a surface of the core carbonaceous material has a low-crystallinity structure.

2. The carbonaceous electrode material for a secondary battery according to claim 1,
wherein the metallic material constituting the surface covering layer is a material shape-controlled to have at least one shape selected from the group consisting of a hollow spherical shape, a spherical shape and a rod shape.

3. The carbonaceous electrode material for a secondary battery according to claim 1,
wherein the metallic material constituting the surface covering layer is a material composed of at least one selected from the group consisting of silver (Ag), silicon (Si) and tin (Sn).

4. The carbonaceous electrode material for a secondary battery according to claim 1.
wherein the graphite constituting the core carbonaceous material is a material composed of at least one selected from the group consisting of natural graphite and synthetic graphite.

5. The carbonaceous electrode material for a secondary battery according to claim 1.
wherein the pitch which is an amorphous carbonaceous material is a material composed of at least one selected from the group consisting of petroleum pitch and coal pitch.

6. A secondary battery using, as a battery anode, the carbonaceous electrode material for a secondary battery as defined in claim 1.

7. The secondary battery according to claim 6,
wherein the secondary battery has a discharging capacity of 400 mAh/g or more, a charging/discharging efficiency of 88% or more and an electrode expansion ratio of 150% or less.

8. A process for producing a carbonaceous electrode material for a secondary battery, comprising:
(S1) weighing a core carbonaceous material composed of high-crystallinity graphite, a pitch which is an amorphous carbonaceous material, and a shape-controlled metallic material powder;
(S2) dissolving the amorphous carbonaceous material in tetrahydrofuran (THF) and adding the shape-controlled metallic material powder thereto, followed by mixing the amorphous carbonaceous material and the shape-controlled metallic material powder while stirring;
(S3) adding the core carbonaceous material composed of the high-crystallinity graphite to the mixture of the step (S2) and mixing the resultant mixture by means of wet stirring, followed by drying the mixture; and
(S4) calcining the mixture of the step (S3).

9. The process for producing a carbonaceous electrode material for a secondary battery according to claim 8, further comprising a step of distributing the calcined material to remove a fine powder after the calcination step (S4).

10. The process for producing a carbonaceous electrode material for a secondary battery according to claim 8,
wherein the metallic material of the step (S1) is a material shape-controlled to have at least one shape selected from the group consisting of a hollow spherical shape, a spherical shape and a rod shape.

11. The process for producing a carbonaceous electrode material for a secondary battery according to claim 8,
wherein the metallic material of the step (S1) is a material composed of at least one selected from the group consisting of silver (Ag), silicon (Si) and tin (Sn).

12. The process for producing a carbonaceous electrode material for a secondary battery according to claim 8,
wherein the high-crystallinity graphite constituting the core carbonaceous material of the step (S1) is a material composed of at least one selected from the group consisting of natural graphite and synthetic graphite.

13. The process for producing a carbonaceous electrode material for a secondary battery according to claim 8,
wherein the pitch which is an amorphous carbonaceous material of the step (S1) is a material composed of at least one selected from the group consisting of petroleum pitch and coal pitch.

14. The process for producing a carbonaceous electrode material for a secondary battery according to claim 8,
wherein the material/powder mixture prepared in (S1) is prepared as a mixture comprising:
70 to 95% by weight of the core carbonaceous material;
5 to 30% by weight of the amorphous carbonaceous material; and
1 to 5% by weight of the metallic material.

15. The process for producing a carbonaceous electrode material for a secondary battery according, to claim 8,
wherein the drying step after mixing by means of the wet stirring (S3) is carried out by adding the core carbonaceous material, composed of the high-crystallinity graphite, to the mixture of the step (S2) and wet-stirring the resultant mixture at a room temperature for at least 2 hours, followed by drying the mixture for at least 4 hours under a reduced pressure while stirring.

16. The process for producing a carbonaceous electrode material for a secondary battery according to claim 8,
wherein the calcination step (S4) is carried out by calcining the mixture, obtained in the step (S3), at 800 to 1,000° C. for 1 to 24 hours.

17. A secondary battery produced using, as a battery anode, the carbonaceous electrode material for a secondary battery produced as defined in claim 8.

18. The secondary battery according to claim 17,
wherein the anode material of the secondary battery has a discharging capacity of 400 mAh/g or more, a charging/discharging efficiency of 88% or more and an electrode expansion ratio of 150% or less.
